(19) United States
(12) Patent Application Publication
(10) Pub. No.: US 2007/0085275 A1
(43) Pub. Date: Apr. 19, 2007

(54) Sealing assembly with a diagonal seal

(75) Inventor: Gad Shelef, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: g-2 Engineering

(21) Appl. No.: 11/249,907

(22) Filed: Oct. 14, 2005

(51) Int. Cl. F16L 17/00

(52) U.S. Cl. 277/314

(57) ABSTRACT

In a most general form the sealing system of the invention may be described as a system comprised of a pair of clamping members and a sealing member between them. The sealing member is defined by a generatrix following a closed-loop curved line around the longitudinal axis. In any partial cross section in a plane perpendicular to a projection of a tangent of the closed-loop curved line onto the plane P, the generatrix of the sealing member has a substantially diagonal orientation between the clamping members. When the clamping members are moved towards each for clamping the sealing member, the axial clamping force is magnified and converted into a compression force along the generatrix.

### FIELD OF THE INVENTION

The present invention relates to the field of sealing devices, and more particularly, to metallic sealing of the joints between opposed parallel surfaces such as for instance, the end flanges by which a pressurized content of a vessel, cylinder, etc. is separated and sealed from the surrounding atmosphere or from another pressurized medium. In such assemblies the flanges are normally connected together by studs, or bolts with nuts, or wedged together by other rings. The sealing assembly of the invention may find application in high-pressure or high-vacuum systems where leakage of the medium may be critical.

### BACKGROUND OF THE INVENTION

There exists a great variety of sealing assemblies and systems for sealing containers or vessels that are filled with a gaseous or liquid media under high-pressure or high-vacuum and that are closed and sealed via interconnection of two flanged elements fixed to each other by bolts or studs with nuts.

For example, U.S. Pat. No. 5,669,612 issued in 1997 to T. Nicholson describes a sealing assembly that contains an API (American Petroleum Institute) groove seal in the form of a metal ring of cross-section like a capital Greek letter omega arranged so that the tips of its limbs provide the sole contact with the groove base before and after compression. The central or heel region may abut on the outer side wall of the groove. A family of seals for different pressure ratings has a common profile, differing only in respect of the thickness of the limbs. These seals were specified by API for sealing pipeline flange joints by location in opposed grooves in the flange faces. The standard API groove cross-section is a symmetrical trapezium, receiving an octagonal sealing ring.

U.S. Pat. No. 6,409,180 issued in 2002 to J. Spence et al. discloses a metallic seal assembly with a metallic seal that concentrates the available load over a narrow band to produce a sealing dam over a sufficient width to minimize leakage on a molecular level. The metallic seal has a first annular beam section, a second annular beam section, and inner and outer surfaces extending between the first and second annular beam sections. One of the inner and outer surfaces has an annular recess that at least partially defines an annular column section of material extending substantially perpendicular between said first and second annular beam sections thereto. The first annular beam section has a first non-sealing surface and a first raised portion with a first annular sealing surface facing in a first axial direction to contact a first member for creating a first annular sealing dam therebetween. The second annular beam section has a second non-sealing surface and a first raised portion with a second annular sealing surface facing in a second axial direction, which is opposite to the first axial direction, to contact a second member for creating a second annular sealing dam therebetween. The annular inner surface extends between the first and second sealing surfaces to form a central passageway. The metallic seal is used to create a seal between a pair of mating surfaces of a first member and a second member. First and second members are coupled together by a plurality of fasteners or bolts. By tightening the fasteners the seal is loaded, and thus, compressed to plastically deform and create an annular seal between the first and second members.

Unexamined US Patent Application Publication No. 2002/0117814A1 published in 2002 (inventor H. Halling, et al.) relates to a resilient seal that has an annular curved region having a generally C-shaped cross section, and a pair of annular leg regions. Each leg region has a free end and extends generally radially inward towards the inside of the C-shaped cross section. The leg regions contact each other and each form a generally frusto-conical disk spring member extending inwardly from the curved region. The leg regions are adapted to contact each other and to provide a restoring force when the sealing ring is compressed. A first bend connects one of said leg regions to the curved region, and a second bend connects the other of the leg regions to the curved region.

Unexamined US Patent Application Publication No. 2005/0023769A1 published in 2005 (inventor H. Halling) relates to a resilient, annular, metallic seal member having a generally “j” shaped cross-section. The annular, metallic seal member includes a first end portion having a first distal end, a generally curled second end portion that extends to a second distal end, and a central body portion between and contiguous with the first and second end portions. The annular, metallic seal member has a first side and an opposite second side. The second end portion curls in a first direction in accordance with a predetermined radius such that the second distal end is located across from the first side of the annular, metallic seal member and the first and second distal ends do not face each other.

Published UK Patent Application 2375575 published in 2002 (inventor R. Quoiani) relates to a sealing assembly with a compressible metallic sealing element that has a hollow wall of concertina or bellows shaped filled with an easily-deformable, relatively-incompressible substance such that axial compression of the seal causes the seal to bulge transversely and thus to seal the connection. The seal may be used between a casing string and a tube hanger in oil or gas wells. Although in this device a sealing force is to some extent amplified by the geometry of the seal and flanges, this amplification is very small. The seal has a complicated configuration and in the case of ultra-high vacuum will produce a large dead volume that may create a virtual leakage. Virtual leak comes into play at ultra-high vacuum. Since it is not leaking from the outside, but from the entrapped volume, its source is not detectable by introducing helium around the vessel. The higher the vacuum, the longer it would take this leak to diminish.

A common disadvantage of all sealing systems known to the applicants, including those described above, is that they either have a complicated shape or complicated design composed of several components. Therefore, the known sealing systems are expensive in manufacture and complicated in assembling and maintenance. Furthermore, the structure of known sealing assemblies cannot provide conversion of flange tightening force into amplified sealing force but rather squeezes the seal without protection against leakage through the area of interface between the side walls of the seal and the mating surfaces of the flanges, or the like.

### SUMMARY

It is an object of the present invention to provide a sealing system that is characterized by extreme simplicity of construction, converts the flange tightening force into a magnified sealing force, prevents occurrence of a virtual leak from a dead volume of the sealing unit, is simple to assembly, and reliable in operation.

A sealing system of the invention is characterized by extreme simplicity and low manufacturing cost.

In a most general form the sealing system of the invention may be described as a system having a longitudinal axis and a plane P perpendicular thereto and comprising a first clamping member, a second clamping member, and a sealing member between said first clamping members and said second clamping member. The aforementioned sealing member is defined by a generatrix following a closed-loop curved line around the longitudinal axis, and in any partial cross section in a plane perpendicular to a projection of a tangent of the closed-loop curved line onto the plane P, the first clamping member has a first thrust point at a first distance from the longitudinal axis, and the second clamping member has a second thrust point at a second distance from the longitudinal axis. These distances are different. The first thrust point and the second thrust point are located at different levels along the longitudinal axis. The generatrix of the sealing member has a substantially diagonal shape in the form of a line connecting the first thrust point and the second thrust point. This line forms a shallow angle to the plane P, and when the first clamping member and the second clamping member are moved towards each other along the longitudinal axis and clamped together by a clamping force, the clamping force is magnified and converted into a compression force in the sealing member along the aforementioned line, the magnification being equal to the reciprocal of the sine of the shallow angle, causing the shallow angle to become even shallower, thus increasing the magnification.

According to a simplified embodiment, the system consists of two symmetrical interconnectable clamping or flanged members having flanges with cylindrical shoulders. Each shoulder forms a corner with its respective flange. The outer diameter of the shoulder of one of the flanged members is smaller than the inner diameter of the shoulder on the mating flanged member. The sealing element of the system is comprised of a hollow body of revolution, preferably from a thin-wall metal in the form of a truncated cone. The sealing element is placed between the clamping or flanged members so that in a longitudinal cross-section of the assembly the sealing element forms a diagonal between the apices of the corners formed between the flanges and their respective shoulders. This diagonal is inclined at an acute angle to a plane perpendicular to the longitudinal axis of the sealing device. In other words, the truncated-cone sealing element is arranged so that the edge of its smaller-diameter end face thrusts against the circular line of intersection of the first flange with its smaller diameter shoulder, while the edge of its larger-diameter end face thrusts against the circular line of intersection of the second flange with its larger diameter shoulder. When in the assembling operation the flanges move towards each other and tightened by bolts, studs, or the like, and the distance between the flanges is shortened, the truncated-cone seal is compressed in the aforementioned diagonal direction, i.e., in the direction of the conical wall of the seal, and the compression force is magnified as the compression progresses.

The sealing system of the last-mentioned embodiment operates in the same manner as has been described for the general case. Since the seal is a body of revolution, at each radial cross-section of the sealing system the two flanges constrain the seal in such a way that the imaginary line between the contact points of the seal and the two flanges is at a shallow angle to a plane perpendicular to the axis of revolution. As the flanges are brought together when the seal is tightened, the aforementioned line undergoes rotation and compression. As a result, the compression force becomes much higher than the mating force (reciprocal to the sine of the angle), and the stresses (which are mainly radial, rather than axial) are borne by the flanges rather than by the mating bolts.

Thus, it can be seen that in the sealing assembly of the invention the sealing force is amplified by the geometry of the seal and flanges and reaches the magnitude many time greater than the force used to mate the flanges. The clamping members as well as the sealing member may have symmetrical or asymmetrical shapes, parallel or non-parallel end faces, flat or non-flat end faces, provided that the conditions described above are observed. The sealing member generatrix may have a linear, curved or zigzag configuration. In the first case the seal will work as a compressive seal, and in the other cases as a flexural seal.

### BRIEF DESCRIPTION OF THE DRAWINGS

FIG. 1 is a fragmental longitudinal sectional view of a sealing system of the invention illustrating positions of the parts prior to tightening the seal.

FIG. 2 is a view similar to FIG. 1 illustrating positions of the parts after the seal is tightened.

FIG. 3A is a diagram that shows variation of the angle of inclination of the sealing member and direction of the compressive force.

FIG. 3B is a longitudinal sectional view of the sealing element of the invention.

FIG. 4 is a fragmental view of the seal of the invention showing a flat end face on the edge of the seal wall.

FIG. 5 is a fragmental view of the seal of the invention showing a rounded end face on the edge of the seal wall.

FIG. 6 is a fragmental view of the seal of the invention showing a beveled end face on the edge of the seal wall.

FIG. 7 shows a curved sealing element of the invention.

FIG. 8 shows a zigzag-shaped sealing element of the invention.

FIG. 9 is a cross-sectional view of the sealing member that has an oval transverse cross-section.

FIG. 10 is a cross-sectional view of the sealing member that has an ellipsoidal transverse cross-section.

FIG. 11 is a cross-sectional view of the sealing member that has a substantially circular, oval, or elliptical transverse cross-section.

FIG. 12 is a view similar to FIG. 2 showing a sealing member with irregularly shaped end faces.

FIG. 13 is a three-dimensional view of a sealing member having an irregular shape.

FIG. 14 is a side view of a sealing member according to another embodiment of the invention.

FIG. 15 is a sectional view similar to FIG. 1 illustrating an embodiment where the sealing member is made integrally with a first clamping member.

FIG. 16 is a sectional view similar to FIG. 1 illustrating an embodiment where the sealing member is made integrally with a second clamping member.

### DETAILED DESCRIPTION OF THE INVENTION

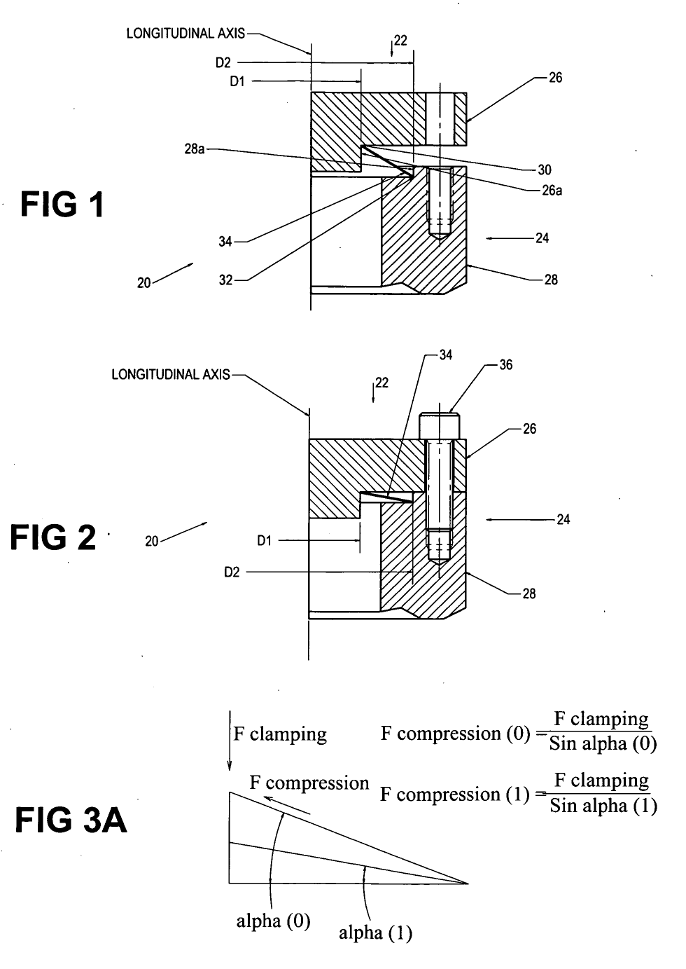

A sealing system according to one embodiment of the invention is shown in FIGS. 1 and 2, where FIG. 1 is a fragmental longitudinal sectional view of a sealing system illustrating positions of the parts prior to tightening the seal, and FIG. 2 is a view similar to FIG. 1 illustrating positions of the parts after the seal is tightened. FIGS. 1 and 2 show only the right half-part of the sealing system since the left half-part is symmetrical. In the embodiment of FIGS. 1 and 2, the sealing member has a regular shape and is made in the form of a truncated cone.

As can be seen from the drawings, the sealing system of FIGS. 1 and 2 that in general is designated by reference numeral 20 is characterized by extreme simplicity and low manufacturing cost. The system 20 consists of two interconnectable clamping or flanged members, hereinafter referred to as flanged members 22 and 24 having flanges 26 and 28 with cylindrical shoulders 26a and 28a. Each shoulder forms a corner with its respective flange. Thus, the flange 26 and its shoulder 26a form a corner area with the point of intersection designated by reference numeral 30. Hereinafter, this point of intersection will be referred to as a first thrust point 30. Similarly, the flange 28 and its shoulder 28a form a corner area with the point of intersection designated by reference numeral 32. Hereinafter, this point of intersection will be referred to as a second thrust point 32.

The first thrust point 30 of the flanged member 22 is located on a diameter D1 of the shoulder 26a which is smaller than the diameter D2 at location of the second thrust point 32 in the corner of the shoulder 28a of the flange member 24. In other words, the first thrust point 30 is located at a shorter distance from the longitudinal axis X-X of the sealing system 20 than the second thrust point 32.

The heart of the system 20 is a sealing member 34, which is a body of revolution made, e.g., from a thin-wall metal in the form of a truncated cone that in a longitudinal cross section has a trapezoidal shape shown in FIG. 3B. The sealing member can be made from aluminum. The materials, dimensions and wall thickness of the sealing member 34 may vary in a wide range depending on a specific application of the sealing system, structure, materials, and dimensions of the flanged members, but in general the tapering angle α of the truncated cone may vary within the range of 1° to 89°, preferably, 10° to 20° with dimensions of the larger diameter from 12 mm to 2500 mm to and dimensional of the smaller diameter ranging from 12 mm to 2500 mm.

As shown in FIGS. 1 and 2, the sealing member 34 is placed between flanges 26 and 28 of the flanged members 22 and 24 so that the upper or smaller diameter end face 34a is brought in contact with the first thrust point 30, and the larger diameter end face is brought in contact with the second thrust point 32. During assembly of the system, the sealing member 34 is first placed onto the second flanged member so that its lower or larger diameter end face 34b rests on the second shoulder 28b, and then the first flanged member 26 is placed from above with its face 26b onto the upper or smaller diameter end face 34a of the sealing member 34.

In the embodiment of the invention shown in FIGS. 1 and 2, the flanges are tightened together by means of bolts, such as a bolt 36 shown in FIG. 2, that are inserted into aligned openings, such as openings 38 and 40 shown in FIG. 1, of which opening 40 has an internal thread for threaded engagement with the thread of the bolt 36. It is understood that such a tightening mechanism is shown only as an example and that the sealing system can be tightened to position of the parts shown in FIG. 2 by any other suitable means which are beyond the scope of the present invention.

It can be seen from FIG. 2 that in a closed state of the sealing system 20, the first thrust point 30 and the second thrust point 32 are located at different height level in the direction parallel to the longitudinal axis X-X. This feature, in combination with the fact that the thrust points 30 and 32 are located on different diameters, provides a shallow diagonal arrangement of the sealing member 34 between the flanged members 22 and 24 when the sealing member 34 is fixed and tightened in the operative position of the system shown in FIG. 2.

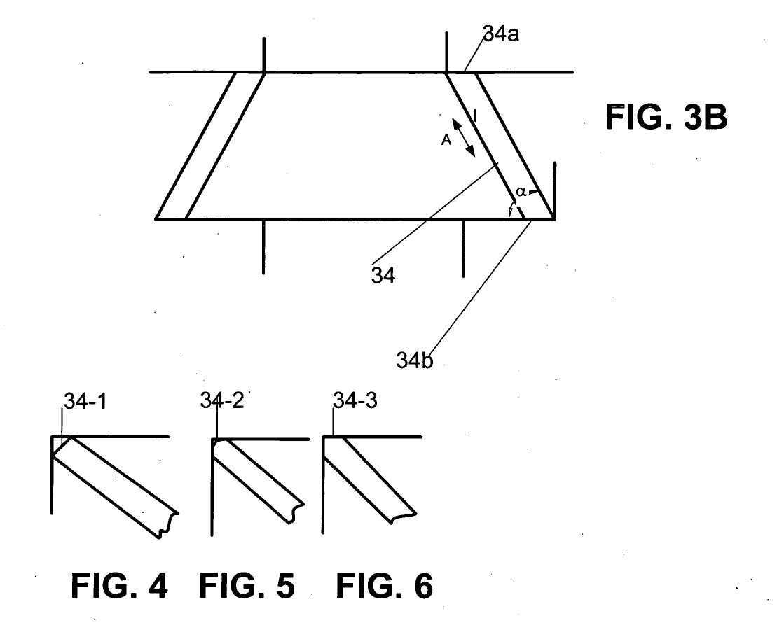

When in the assembling operation the flange members 22 and 24 move towards each other from the position of FIG. 1 to position of FIG. 2 and tightened by bolts, such as the bolt 36 (FIG. 2), or the like, and the distance between the flanges 26 and 28 is shortened, the truncated-cone sealing member 34 is compressed in the aforementioned diagonal direction, e.g., in the direction of the conical wall of the seal shown by arrow A in FIG. 3B. During tightening, the sealing element is deformed and compressed, and the cone becomes shallower. The end faces of the sealing member 34 that are in contact with the thrust points 30 and 32 may be flat (an end face 34-1 in FIG. 4), rounded (an end face 34-2 in FIG. 5), or beveled (an end face 34-3 in FIG. 6).

The sealing system of the invention operates as follows. Since the sealing member 34 is a body of revolution (FIG. 3B), at each radial cross-section of the sealing system the two flanges 26 and 28 constrain the sealing member 34 in such a way that the imaginary line between the contact points of the seal and the two flanges is at a shallow angle α to a plane perpendicular to the axis of revolution, i.e., to the longitudinal axis X-X. As the flanges 26 and 28 are brought together when the sealing member 34 is tightened (FIG. 2), the aforementioned line between the contact points undergoes rotation and compression. As a result, the compression force becomes much higher than the tightening force of the bolts such as the bolt 36 (by a ratio reciprocal to the sine of said angle), and the stresses (which are radial, rather than axial) are borne by the faces 26a and 28a of the flanges 26 and 28 (FIG. 1) rather than by the mating bolts.

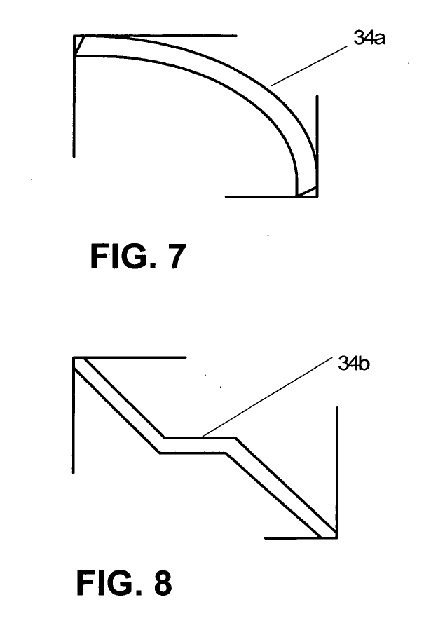

It has been shown that in the sealing system of FIGS. 1-3 the sealing force is amplified by the geometry of the sealing member 34 and flanges 26 and 28 and reaches the magnitude many time greater than the force used to mate the flanges. In the embodiment of the invention shown in FIGS. 1-6, the seal cone has a linear generatrix. However, if necessary, a sealing member 34a may have a curvilinear generatrix shown in FIG. 7 or a zigzag-shaped generatrix shown in FIG. 8 for a sealing member 34b. In the first case (FIGS. 1-3) the sealing member 34 will work as a compressive seal, and in the case of sealing members 34a and 34b as a flexural seal.

Thus, it has been shown that in the embodiment of the sealing system shown in FIGS. 1-3, the system has a longitudinal axis X-X and comprises a first clamping member 22, a second clamping member 24, and a sealing member 34 that is clamped between both clamping members 22 and 24. The sealing member has a closed-loop configuration, and in any partial cross section (such as the cross-section shown in FIG. 2 that passes through the right part of the sealing assembly 20) the first and second clamping members 22 and 24 have respective thrust points 30 and 32 of contact with the sealing member 34. These points of contact are located at different distances D1 and D2 from the aforementioned longitudinal axis and at different levels along the longitudinal axis, so that in a position clamped between the clamping members 22 and 24 the sealing member 34 assumes a diagonal orientation in the form of a line that connects both thrust points 30 and 32. This line is inclined at an acute angle α to a plane perpendicular to the longitudinal axis X-X. The angle α is selected within such a range that a clamping force F_{clamping} developed when the clamping members are moved towards each other is converted and magnified in the sealing member into a compression force acting along the aforementioned line. As shown in FIG. 3A, as the clamping operation progresses, the angle α [alpha (0)] of inclination of the generatrix of the sealing member 34 to the plane perpendicular to the axis X-X is reduced to [alpha (1)] thus increasing the compressive force F_{compression}. This is because the magnification of the compressive force F_{compression}, the direction of which is shown in FIG. 3A by the arrow, is in inverse proportion to the sine of the aforementioned acute angle α. This can be written by the following formula:
F_{compression}=F_{clamping}/Sin α.

In one specific example of the sealing system of FIGS. 1-3, the elements of the sealing system had the following dimension: D1=135 mm, D2=150 mm, angle α=18°. The wall thickness was 1.3 mm. The pressure (vacuum) in the container was 10E⁻⁹ Torr.

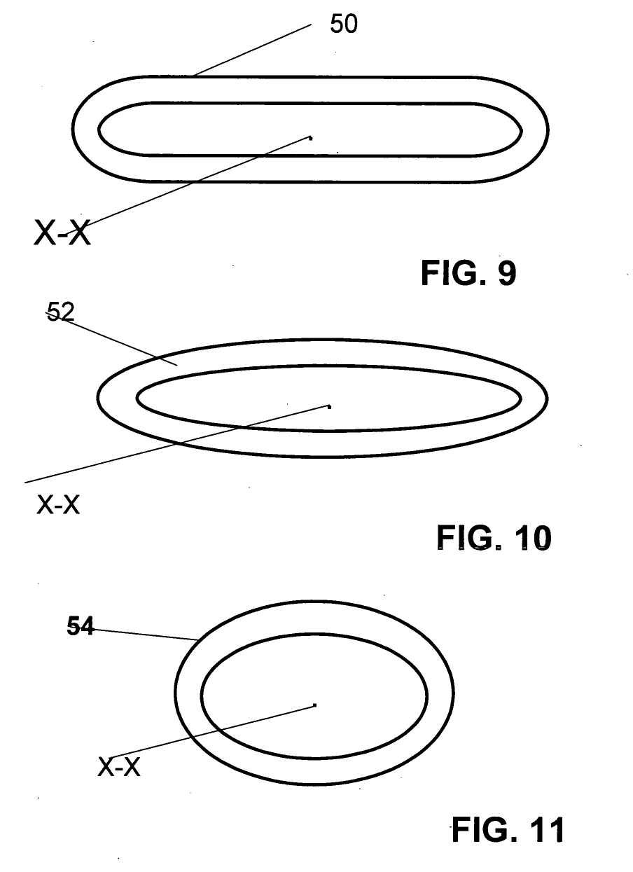

The invention has been described above in the form of a system with symmetrical components, such as regularly shaped symmetrical clamping members and the sealing member, where in a cross-section the seal has a circular configuration. However, the invention is not limited to such an application and the seal may have any other closed-loop configuration in the cross-section perpendicular to the longitudinal axis X-X. For example, a sealing member 50 shown in FIG. 9 may have an oval cross-sectional configuration, a sealing member 52 shown in FIG. 10 may have an ellipsoidal cross-sectional configuration, and a sealing member 54 shown in FIG. 11 may have a substantially circular, substantially oval, or substantially ellipsoidal configuration. The term substantially means that in a cross-sectional configuration the sealing member may not be geometrically strictly circular, oval, or ellipsoidal but rather close to such geometrical shapes.

In a longitudinal cross-section, the sealing system with sealing members 50, 52, and 54 will have the same configuration as shown in FIGS. 1-8. In other words, the sealing system will have the longitudinal axis X-X, will contain a first clamping member such as the member 22, a second clamping member such as the member 24; and a sealing member, e.g., 50, between the first claming member 22 and the second clamping member 52 made, e.g., from a thin-walled metal. In the longitudinal cross section, the first clamping member 22 has a pair of first thrust points arranged symmetrically with respect to each other at first distances (only one such point 30 is shown in FIG. 1 at a distance D1 from the axis X-X as the image corresponds only to a half of the system 20) and the second clamping member 24 has a second pair of thrust points arranged symmetrically with respect to each other at second distances (only one such point 32 is shown in FIG. 1 at a distance D2 from the axis X-X as the image corresponds only to a half of the system 20). The distances D1 and D2 are different and are located at different levels along axis X-X. In a longitudinal cross-section of the system 20 in an assembled state shown in FIG. 2, any of the sealing members 50, 52, and 54 will assume a substantially diagonal position in the form of a diagonal 34 between the first thrust points such as 30 and the second thrust points such as 32, and when the first clamping member 22 and the second clamping member 24 are clamped together by a clamping force (not shown) acting in the direction of axis X-X or parallel to this direction, this clamping force will be converted into a force that compresses the sealing member in the direction of the diagonals such as the diagonal 34.

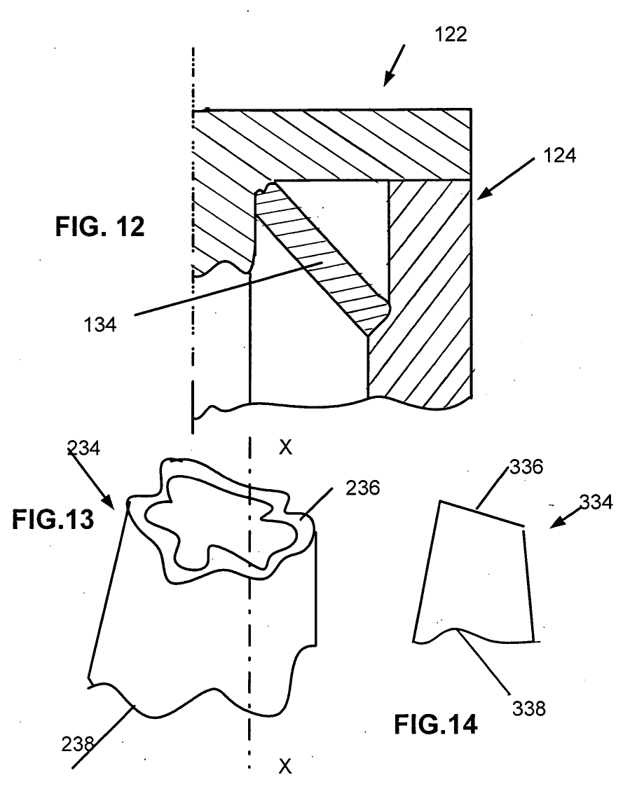

In the embodiments of FIGS. 9-11, the sealing member has a closed-loop configuration, and in any partial cross section that may pass through the aforementioned longitudinal axis X-X (that is shown as a central dot in FIGS. 9-11) the first and second clamping members will have thrust points located at different distances from the aforementioned longitudinal axis and at different levels along the longitudinal axis (the thrust point and their distances from the axis X-X are now shown as the devices of the FIGS. 9-11 will have the same longitudinal cross-sectional views as those shown in FIGS. 1 and 2.) The invention is not limited in its application only to symmetrical or/and regularly shaped components of the sealing system, and the clamping members as well as the sealing member may have any arbitrary irregular and asymmetrical shape, e.g., of the types shown in FIGS. 12-14, where FIG. 12 is a view similar to FIG. 2 that shows a partial longitudinal sectional view of the sealing system having irregularly shaped system components. Thus, FIG. 12 shows irregularly shaped clamping members 122 and 124 and an irregularly shaped sealing member 134. FIG. 13 shows an asymmetrical and irregularly shaped sealing member 234 with uneven upper and lower end faces 236 and 238, the axis X-X is offset from the central part of the sealing member 234. FIG. 14 is a side view of a sealing member 334 with non-parallel end faces, of which an end face 336 is smooth and an end face 338 is uneven, both end faces being inclined to the axis at angles different from 90° C.

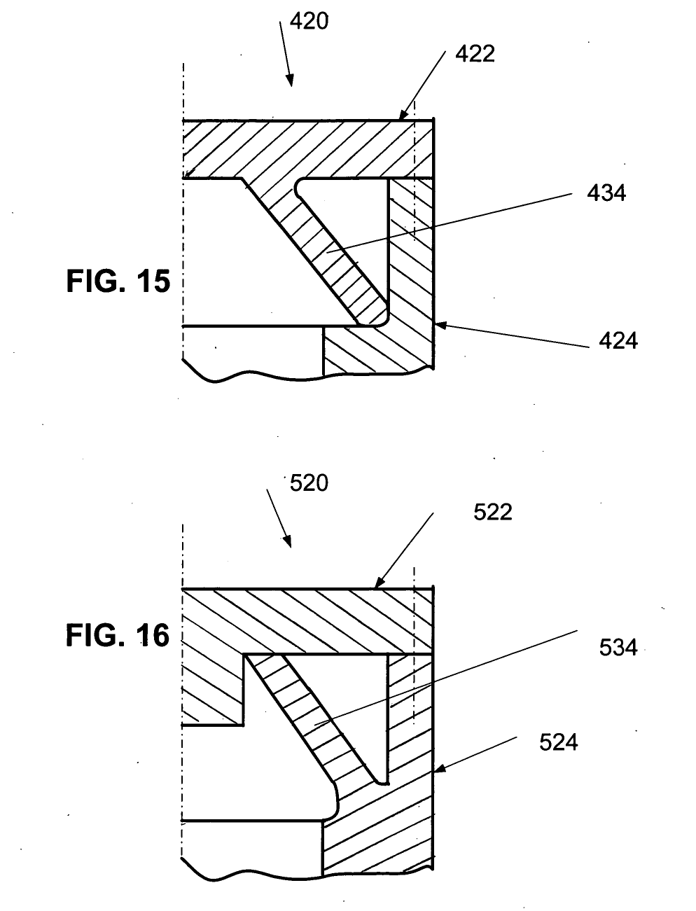

The sealing member of any of the above-described embodiments can be made integrally with any of the clamping members. FIG. 15 is a sectional view similar to FIG. 2 illustrating an embodiment of a system 420 where the sealing member 434 is made integrally with a first clamping member 422. Reference numeral 424 designates the second clamping member.

FIG. 16 is a sectional view similar to FIG. 2 illustrating an embodiment of a sealing system 520 where the sealing member 534 is made integrally with a second clamping member 524. Reference numeral 522 designates the first clamping member.

It has been shown that the principle of the invention is observed in all embodiments, provided that the sealing member has a closed-loop configuration around the longitudinal axis X-X and that in any partial cross section in a plane perpendicular to a projection of a tangent of the closed-loop curved line onto the plane perpendicular to the longitudinal axis, the first clamping member has a first thrust point at a first distance from the longitudinal axis, and the second clamping member has a second thrust point at a second distance from the longitudinal axis. These distances are different, and the thrust points are located at different levels along the longitudinal axis.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the shape of the clamping members and the sealing element may be different from those shown in FIGS. 1-16, provided that the principles of the invention formulated above and in the claims are observed. The shape can be solid or hollow, the latter can be empty or filled with another material. What is meant under the term “flanged members” is not necessarily casing parts or covers with flanges but any parts that have means for clamping them together with diagonal arrangement of the generatrix of the seal between two thrust points. Sealing of high pressure, high temperature piping joints may employ a plurality of the sealing elements with outer and inner tubular spacers between them. The sealing element can be a relatively rigid core to take the compression force, coated by a softer material for the actual seal. The sealing edges 34a and 34b in FIGS. 1 and 2 can be shaped to act with faces 26a and 28 and to further reduce the potential for a virtual leak.

1. A sealing system having a longitudinal axis and a plane P perpendicular thereto and comprising a first clamping member, a second clamping member, and a sealing member between said first clamping member and said second clamping member, wherein said sealing member is defined by a generatrix following a closed-loop curved line around said longitudinal axis, and in any partial cross section in a plane perpendicular to a projection of a tangent of said closed-loop curved line onto said plane P said first clamping member has a first thrust point at a first distance from said longitudinal axis, said second clamping member has a second thrust point at a second distance from said longitudinal axis, said first distance and said second distance being different, said first thrust point and said second thrust point being located at different levels along said longitudinal axis, said generatrix of said sealing member having a substantially diagonal shape in the form of a line connecting said first thrust point and said second thrust point, said line forming an acute angle to said plane P, and when said first clamping member and said second clamping member are moved towards each other along said longitudinal axis and clamped together by a clamping force, said clamping force is magnified and converted into a compression force in said sealing member along said line, said magnification being equal to the reciprocal of the sine of said acute angle, causing said acute angle to become shallower, thus increasing said magnification.

2. The sealing system of claim 1, wherein said acute angle is selected within the range of 1° to 89°.

3. The sealing system of claim 1, wherein said sealing member has a substantially uniform thickness, said closed-loop configuration being selected from the group consisting of a substantially circular configuration, a substantially oval configuration, a substantially elliptical configuration, and an arbitrary configuration; and wherein in a longitudinal cross-section of said sealing member, said sealing member having a substantially trapezoidal shape.

4. The sealing system of claim 3, wherein said acute angle is selected within the range of 1° to 89°.

5. The sealing system of claim 1, wherein in said first thrust point and said second thrust point, said first clamping member and said second clamping member have arbitrary profiles and wherein said sealing member has end faces mating with said arbitrary profiles.

6. The sealing system of claim 2, wherein in said first thrust point and said second thrust point, said first clamping member and said second clamping member have arbitrary profiles and wherein said sealing member has end faces mating with said arbitrary profiles.

7. The sealing system of claim 4, wherein in said first thrust point and said second thrust point, said first clamping member and said second clamping member have arbitrary profiles and wherein said sealing member has end faces mating with said arbitrary profiles.

8. The sealing system of claim 5, wherein said acute angle is selected within the range of 1° to 89°.

9. The sealing system of claim 1, wherein said sealing member is made from a thin-wall metal.

10. The sealing system of claim 7, wherein said sealing member is made from a thin-wall metal.

11. The sealing system of claim 6, wherein said sealing member is made from a thin-wall metal.

12. The sealing system of claim 11, wherein said sealing member has a substantially uniform thickness, said closed-loop configuration being selected from the group consisting of a substantially circular configuration, a substantially oval configuration, a substantially elliptical configuration, and an arbitrary configuration; and wherein in a longitudinal cross-section of said sealing member, said sealing member having a substantially trapezoidal shape.

14. The sealing system of claim 2, wherein:
said first clamping member comprises a first flanged member in the form of a first body of revolution around said longitudinal axis, said first body of revolution having a first diameter, and said first thrust point is located on said first diameter and at a first level of height relative to said longitudinal axis;
said second clamping member comprises a second flanged member in the form of a second body of revolution around said longitudinal axis, said second body of revolution having a second diameter that is larger than said first diameter, and a second thrust point is located on said second diameter and at a second level of height relative to said longitudinal axis that is lower than said first level of height provided that said first flanged member is located above said second flanged member;
means for clamping said first flanged member and said second flanged member to each other;
said sealing member comprising a body of revolution around said longitudinal axis in the form of a truncated cone and has a small-diameter side and a large-diameter side and is positioned so that in a longitudinal cross-section of said sealing system the end of a generatrix of said truncated cone on said small-diameter side is located in said first thrust point, and the end of said generatrix on said large-diameter side is located in said second thrust point.

15. The sealing system of claim 14, wherein said means for clamping are threaded fasteners.

16. The sealing member of claim 15, wherein the shape of said generatrix is selected from the group consisting of a straight line, a curved line, and a zigzag line.

17. The sealing member of claim 1, wherein the shape of said generatrix is selected from the group consisting of a straight line, a curved line, and a zigzag line.

18. The sealing member of claim 10, wherein the shape of said generatrix is selected from the group consisting of a straight line, a curved line, and a zigzag line.

19. The sealing member of claim 12, wherein the shape of said generatrix is selected from the group consisting of a straight line, a curved line, and a zigzag line.

20. The sealing system of claim 1 where said sealing member is an integral part of said first clamping member or said second clamping member.

21. The sealing system of claim 18 where said sealing member is an integral part of said first clamping member or said second clamping member.

22. The sealing system of claim 19 where said sealing member is an integral part of said first clamping member or said second clamping member.

23. A method of sealing comprising the steps of:
providing a sealing system having a longitudinal axis and a plane P perpendicular thereto and comprising a first clamping member, a second clamping member, and a sealing member between said first clamping member and said second clamping member, wherein said sealing member is defined by a generatrix following a closed-loop curved line around said longitudinal axis, and in any partial cross section in a plane perpendicular to a projection of a tangent of said closed-loop curved line onto said plane P said first clamping member has a first thrust point at a first distance from said longitudinal axis, said second clamping member has a second thrust point at a second distance from said longitudinal axis, said first distance and said second distance being different, said first thrust point and said second thrust point being located at different levels along said longitudinal axis;
placing said sealing member between said first clamping member and said second clamping member so that in said partial cross section said sealing member assumes a substantially diagonal position of a line between said first thrust point and said second thrust point at an acute angle to a plane P perpendicular to said longitudinal axis;
clamping said sealing member between said first clamping member and said second clamping member with a clamping force acting in said longitudinal direction by moving said first clamping member and said second clamping member towards each other; and
converting said clamping force into a compression force acting along said line and magnifying said compression force with an increase of said compression force since said compression force is in inverse proportion to the sine of said acute angle.
